(19) United States
(12) Patent Application Publication
(10) Pub. No.: US 2007/0147065 A1
(43) Pub. Date: Jun. 28, 2007

(54) LIGHTING DEVICE AND PROJECTOR

(75) Inventor: Mitsuo NAGATA, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/567,617

(22) Filed: Dec. 6, 2006

(30) Foreign Application Priority Data
Dec. 28, 2005 (JP) 2005-377156

(51) Int. Cl. H01S 3/00

(52) U.S. Cl. 362/553; 362/259; 362/326

(57) ABSTRACT

A lighting device includes: a light source which supplies a beam; a shaping optical portion which shapes the beam into a linear luminous flux approximately parallel to a first direction; and a scanner which causes the linear luminous flux to scan in a second direction approximately perpendicular to the first direction.

### BACKGROUND

1. Technical Field

The present invention relates to a technology of a lighting device and a projector, in particular to a lighting device using a laser beam.

2. Related Art

In recent years, in conjunction with an increase in output of a laser diode and a development of a blue laser diode, a projector and a display displaying an image using a laser beam have been proposed. A laser beam has features such as a high color purity due to being of a single wavelength, and a high coherence enabling an easy shaping. Compared with an ultra-high pressure mercury-vapor lamp etc. used to date, a laser light source has advantages such as being compact, and being capable of instantaneous illumination. As such, by using laser beams, a display of a high quality image by means of a compact configuration can be expected. In the event that the laser light source is replaced with the ultra-high pressure mercury-vapor lamp used to date, in order to obtain a sufficient brightness, a use of an array laser, disposing a plurality of laser light sources in an array formation, can be considered. A technology of a lighting device using the array laser is proposed in, for example, JP-A-2003-149594 and JP-A-2003-270585.

A liquid crystal display device or a minute mirror array device used as a spatial light modulator of a projector has a feature that a luminance of an image in a one frame period of an image signal is maintained approximately constant. In a case of using a so-called hold type spatial light modulator of this kind, it can happen that there is a reduction in moving picture response due to movement blur occurring when displaying a moving picture. By using a laser light source in conjunction with the hold type spatial light modulator, it can be hoped that it is possible to lessen such a reduction in moving picture response. Also, as a laser beam has a high coherence, there is a high tendency to cause a so-called speckle pattern, in which bright spots and dark spots are distributed randomly in an illumination area. In the event that a speckle occurs in a laser beam which has been enlarged and shaped in order to display an image, a viewer will be presented with a shiny flickering impression, having an adverse effect on an image appreciation. For this reason, it is also hoped to be able to reduce the speckle.

### SUMMARY

An advantage of some aspects of the invention is to provide a lighting device which can lessen a reduction in moving picture response, and reduce speckle, when used in conjunction with the hold type spatial light modulator, and a projector.

In order to solve the above mentioned problem, and to achieve the advantage, according to an aspect of the invention, it is possible to provide a lighting device including: a light source which supplies a beam; a shaping optical portion which shapes the beam into a linear luminous flux approximately parallel to a first direction; and a scanner which causes the linear luminous flux to scan in a second direction approximately perpendicular to the first direction.

By causing the linear luminous flux approximately parallel to the first direction to scan in the second direction, it is possible to make an illumination area in each instant one portion of an illumination object, and to illuminate the whole illumination object in a time taken causing the linear luminous flux to scan once in the second direction. In a case of having a spatial light modulator as the illumination object, one portion of pixels is illuminated in each instant. By one portion of the pixels being illuminated in each instant, it is possible to make an illumination time for each pixel shorter than when illuminating all the pixels at once. By shortening the illumination time for each pixel, when using the lighting device in conjunction with a hold type spatial light modulator, it is possible to reduce the moving picture movement blur. Also, as a size of an illumination area in each instant is reduced, it is possible to make a speckle less noticeable compared with when enlarging the beam in the first direction and the second direction. Furthermore, by using the scanner to cause the linear luminous flux to scan, it is also possible to change a speckle pattern on the illumination object. By superimposing a variety of speckle patterns on the illumination object, it is possible to make a recognition of a specific speckle pattern difficult, enabling an effective reduction of the speckle. In this way, it is possible to obtain a lighting device which, when used in conjunction with the hold type spatial light modulator, can lessen a reduction in moving picture response, and reduce the speckle.

Also, a preferable aspect of the invention is that the shaping optical portion makes a light quantity distribution of the linear luminous flux approximately even. By causing the linear luminous flux for which the light quantity distribution has been made approximately even to scan, it is possible to obtain an illumination beam with an approximately even light quantity distribution.

Also, a preferable aspect of the invention is that the shaping optical portion includes a diffractive optical element which shapes the beam into the linear luminous flux by diffraction. By using the diffractive optical element, it is possible, with a simple configuration, to shape an illumination area of laser beams in keeping with a formation of an illumination object. By using the diffractive optical element, it is also possible to make the light quantity distribution even.

Also, a preferable aspect of the invention is that the lighting device includes: a parallelizing optical portion which parallelizes the linear luminous flux from the shaping optical portion. By this means, it is possible to cause the parallelized light to fall incident on the illumination object.

Also, a preferable aspect of the invention is that the lighting device includes: a focusing optical portion which focuses the linear luminous flux in an optical path between the shaping optical portion and the parallelizing optical portion, wherein the scanner is provided in an optical path between the shaping optical portion and the parallelizing optical portion. After the linear luminous flux has been once focused in the optical path between the shaping optical portion and the parallelizing optical portion, it diffuses. By having a configuration causing the linear luminous flux focused in the optical path between the shaping optical portion and the parallelizing optical portion to fall incident on the scanner, it is possible to make the scanner compact. By this means, it is possible to make a drive motor of the scanner smaller, and to reduce power consumption. Also, it is possible to make the scanner and its peripheral portions compact, leading to a cost reduction and a size reduction of the lighting device.

Also, a preferable aspect of the invention is that the scanner includes a rotating prism which transmits the linear luminous flux while rotating around a rotation axis. By this means, it is possible to cause the linear luminous flux to scan with a simple configuration.

Also, a preferable aspect of the invention is that the scanner includes a reflecting mirror which reflects the linear luminous flux while rotating around a rotation axis. By this means, it is possible to cause the linear luminous flux to scan with a simple configuration. Also, by having a configuration in which the optical path is deflected by the reflecting mirror, it is possible to make the overall length of the lighting device shorter than in a case in which light is caused to proceed in a straight line along every optical path of the lighting device.

Also, a preferable aspect of the invention is that the reflecting mirror deflects the linear luminous flux approximately 90 degrees and causes it to scan. By this means, it is possible to have a lighting device with a compact configuration.

Also, a preferable aspect of the invention is that the light source supplies a plurality of the beams which are isochromatic. The term isochromatic refers to having a mutually identical or similar wavelength band. By this means, by increasing a light quantity of the isochromatic beams and superimposing a speckle pattern for each beam, it is possible to reduce a speckle.

Also, a preferable aspect of the invention is that the light source supplies laser beams, which are the aforementioned beams. A feature of a laser light source is that an etendue, which is a product of an emission area and a radiation angle, is extremely small. As it is easily possible to condense the laser beams, it is quite possible to narrow an illumination area in the illumination object far enough to enable a lessening in a moving picture response reduction.

Also, a preferable aspect of the invention is that the lighting device includes: a plurality of the light sources which supply mutually differing colored lights, wherein the scanner causes the colored lights from the plurality of light sources to scan. By having a configuration in which the scanner causes a plurality of colored lights to scan, it is possible to reduce the number of parts of the lighting device compared with a case in which a scanner is provided for each colored light to reduce a cost of the lighting device, and to make it compact.

Furthermore, according to an aspect of the invention, it is possible to provide a projector including: the aforementioned lighting device; and a spatial light modulator which modulates light from the lighting device in accordance with an image signal. By using the lighting device described heretofore, it is possible to lessen a reduction in a moving picture response when using a hold type spatial light modulator, and to reduce the speckle. By this means, it is possible to obtain a projector capable of displaying a high quality image in which a moving picture blur and speckle have been reduced.

### BRIEF DESCRIPTION OF THE DRAWINGS

The invention will be described with reference to the accompanying drawings, wherein like numbers reference like elements.

FIG. 1 shows an outline configuration of a lighting device 10 according to Embodiment 1 of the invention.

FIG. 2 shows a planar configuration of each portion from a light source to a collimator.

FIG. 3 illustrates a displacement of a linear luminous flux using a rotating prism.

FIG. 4 illustrates an illumination area in an illumination object.

FIG. 5 shows an outline configuration of a lighting device according to a modification example 1 of Embodiment 1.

FIG. 6 shows an outline configuration of a lighting device according to a modification example 2 of Embodiment 1.

FIG. 7 shows a configuration causing the linear luminous flux to focus in a position of a reflecting mirror or a proximity thereof.

FIG. 8 shows a configuration deflecting the linear luminous flux approximately 90 degrees with the reflecting mirror.

FIG. 9 shows an outline configuration of a projector according to Embodiment 2 of the invention.

FIG. 10 shows a configuration providing each light source integrated.

FIG. 11 shows a configuration causing each colored light to scan with one rotating prism.

FIG. 12 shows a configuration causing each colored light to scan with one reflecting mirror.

FIG. 13 illustrates an optical path of an R light.

FIG. 14 illustrates an optical path of a G light.

### DESCRIPTION OF EXEMPLARY EMBODIMENTS

Hereafter, a detailed description will be given of embodiments of the invention, with reference to the drawings.

### Embodiment 1

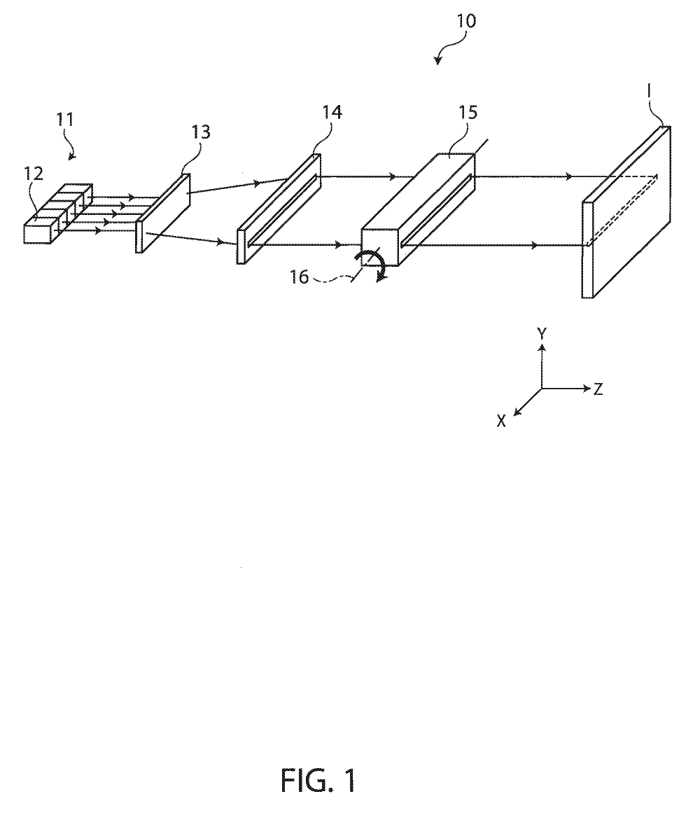

FIG. 1 shows an outline configuration of a lighting device 10 according to Embodiment 1 of the invention. Five edge emitting laser diodes 12 are provided in a light source 11. Each laser diode 12 supplies an isochromatic laser beam, which is a beam. The term isochromatic refers to having a mutually identical or similar wavelength range. The five laser diodes 12 are aligned in an X direction, which is a first direction. The light source 11 supplies five isochromatic laser beams. It is acceptable that the light source 11 uses a wavelength conversion element, for example, a second harmonic generation (SHG) element, to convert a wavelength of the laser beams from the laser diodes 12. Also, it is acceptable that surface emitting laser diodes with five aligned light emitters are used as the light source 11. Furthermore, it is also acceptable to use a diode pumped solid state (DPSS) laser, a solid state laser, a liquid laser, a gas laser or the like in the light source 11, in place of the laser diode.

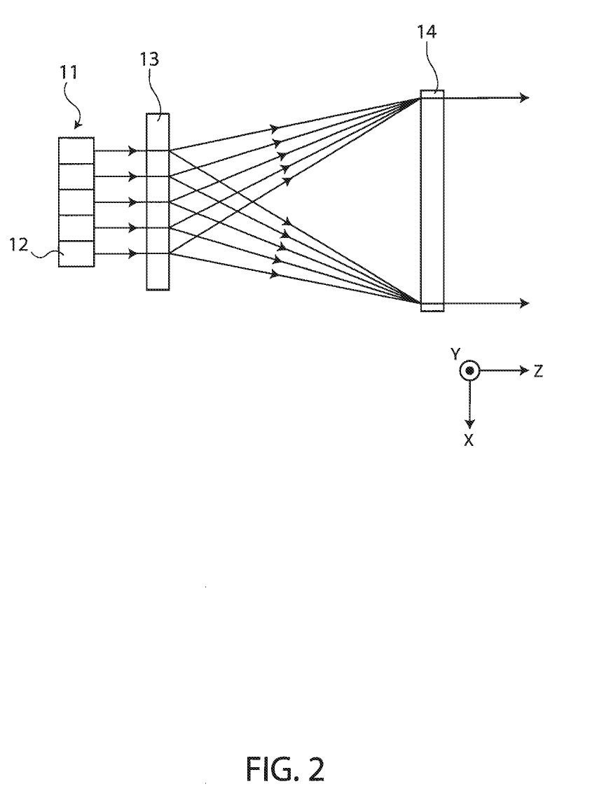

A diffractive optical element 13 is a shaping optical portion which, by diffracting the laser beams, shapes the laser beams into a linear luminous flux approximately parallel to the X direction which is the first direction. Also, the diffractive optical element 13, by superimposing the five laser beams with a collimator 14, makes a light quantity distribution of the laser beams approximately even. It is possible to use, for example, a computer generated hologram (CGH) as the diffractive optical element 13. It is also acceptable to use a lens array which diffuses and superimposes each laser beam as the shaping optical portion, in place of the diffractive optical element 13. The collimator 14 is a parallelizing optical portion which parallelizes the linear luminous flux from the diffractive optical element 13. The diffractive optical element 13 superimposes the linear luminous flux composed of the five laser beams on the collimator 14, in an XZ plane shown in FIG. 2. It is possible to use a diffractive optical element such as a CGH, or a lens, as the collimator 14.

Returning to FIG. 1, a rotating prism 15 is provided in an optical path between the collimator 14 and an illumination object I. The rotating prism 15 is a scanner which causes the linear luminous fluxes to scan in a Y direction, which is a second direction approximately perpendicular to the first direction. The rotating prism 15 includes a glass member having a cuboid shape of which a YZ cross-section forms a square. The rotating prism 15 is configured in such a way as to be able to rotate around a rotation axis 16, which is approximately parallel to an X axis. The rotating prism 15 transmits the linear luminous fluxes while rotating around the rotation axis 16.

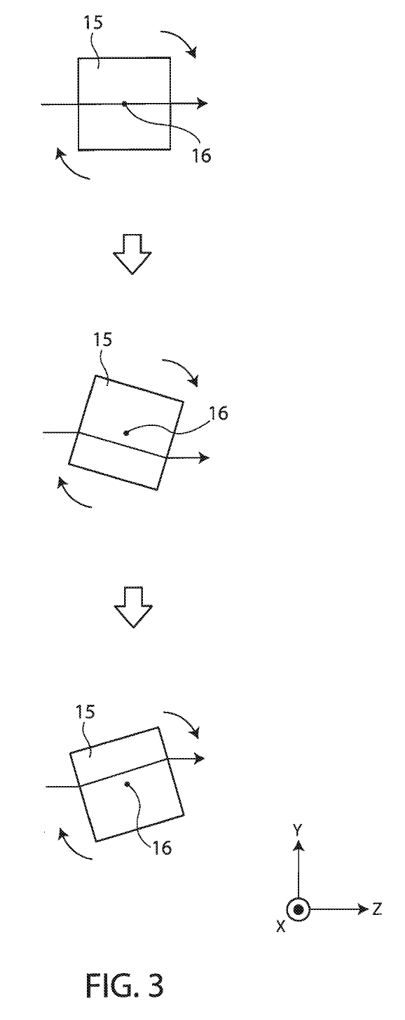

FIG. 3 illustrates a displacement of the linear luminous flux due to rotating the rotating prism 15. As shown in a top level of FIG. 3, in the event that the linear luminous flux falls approximately perpendicular to an incidence surface of the rotating prism 15, the rotating prism 15 causes the linear luminous flux to proceed in a straight line, without refracting it. Next, as shown in a middle level of FIG. 3, it is assumed that the rotating prism 15 has rotated clockwise. In this case, as the linear luminous flux falls diagonally to the incidence surface of the rotating prism 15, the linear luminous flux undergoes a refraction at the incidence surface and an emergence surface of the rotating prism 15. The rotating prism 15 shifts the linear luminous flux to a lower side, which is more minus Y than at a time of incidence on the rotating prism 15. By rotating the rotating prism 15 clockwise, the linear luminous flux scans downward.

Next, as shown in a lower level of FIG. 3, it is assumed that, by the rotating prism 15 further rotating clockwise, a tilt of the rotating prism 15 has become a reverse of that in the middle level of FIG. 3. In this case, the linear luminous flux is refracted in a direction opposite to that in the middle level of FIG. 3. The rotating prism 15 shifts the linear luminous flux to an upper side, which is more plus Y than at a time of incidence on the rotating prism 15. Then, by rotating the rotating prism 15 clockwise, the linear luminous flux scans upward. By repeating this kind of rotation of the rotating prism 15, the linear luminous flux repeats a scanning in the Y direction. The rotating prism 15 can be rotated using, for example, a motor. By using the rotating prism 15, it is possible to cause the linear luminous flux to scan using a simple configuration.

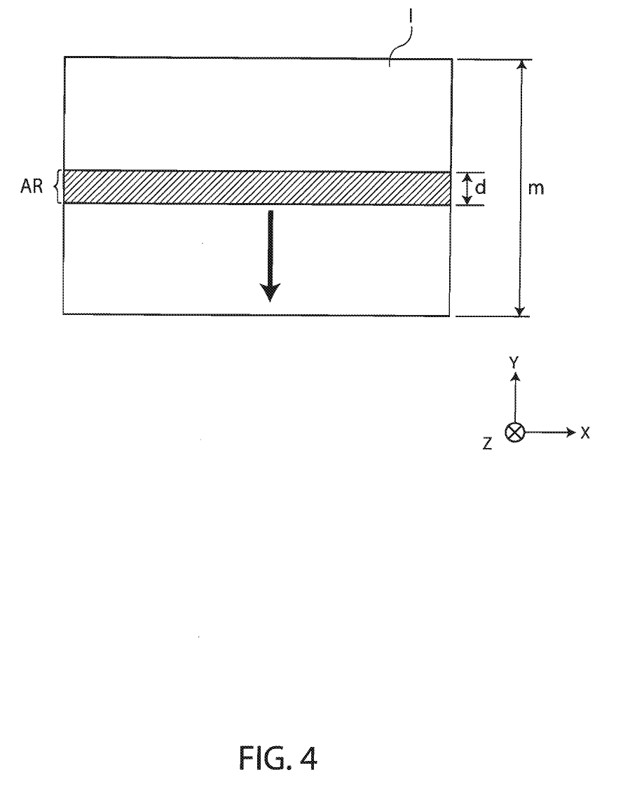

FIG. 4 illustrates a lighting area AR in the illumination object I. By causing a linear luminous flux approximately parallel to the X direction to scan in the Y direction, it is possible to make the lighting area AR in each instant one portion of the illumination object I, and to illuminate the whole illumination object in a time taken causing the luminous flux to scan once in the Y direction. In a case of having a spatial light modulator as the illumination object I, one portion of pixels is illuminated in each instant. By one portion of the pixels being illuminated in each instant, it is possible to make an illumination time for each pixel shorter than when illuminating all the pixels at once.

In a case of a hold type display device with which a luminance of an image in a one frame period of an image signal is maintained approximately constant, compared with a so-called impulse type display device such as a CRT, it can happen that there is a reduction in moving picture response due to movement blur occurring when displaying a moving picture. Details of movement blur are disclosed in, for example, T. Kurita's “Moving Picture Quality Improvement for Hold-Type AM-LCDS (SID 01 Digest, 35. 1” and UP-A-9-325715. By using the lighting device 10 in the embodiment of the invention in conjunction with a hold type spatial light modulator, it is possible to reduce the moving picture movement blur by shortening the illumination time for each pixel.

It is preferable that the illumination time for each pixel is one eighth or less of that when illuminating every pixel at once, for example, approximately 10%. A width d of the lighting area AR with respect to a width m of the illumination object I can be determined in such a way that the illumination time for each pixel is approximately 10% of that when illuminating every pixel at once. By contracting the illumination time for each pixel to one eighth or less of that when illuminating every pixel at once, it is possible to obtain a moving picture response equivalent to a CRT moving picture response.

The rotating prism 15 (refer to FIG. 1) causes the linear luminous flux to scan in synchronization with a writing of image data in the spatial light modulator, which is the illumination object I. Also, it is preferable that a position in which the linear luminous flux is caused to scan by the rotating prism 15 is a position, in the spatial light modulator, of a pixel immediately before that in which next image data is to be written. In this way, it is possible to satisfactorily reduce the moving picture movement blur.

A feature of the laser diodes 12 is that an etendue, which is a product of an emission area and a radiation angle, is extremely small. As it is easily possible to condense the laser beams, it is quite possible to narrow the lighting area AR in the illumination object I in such a way that the illumination time for each pixel is contracted to approximately 10% of that when illuminating every pixel at once. When using laser beams, as it is possible to sufficiently narrow the lighting area without using a slit etc. which blocks a portion of the laser beams, it is possible to lessen a reduction in light use efficiency, and to reduce power consumption. Also, without carrying out a high speed flickering of the light source 11, it is possible to obtain an advantageous effect identical to that obtained when intermittently illuminating the illumination object I.

Also, by reducing a size of the lighting area in each instant, it is possible to make a speckle less noticeable compared with when enlarging the laser beams in the X direction and the Y direction. Furthermore, by using the rotating prism 15 to cause the linear luminous flux to scan, it is also possible to change a speckle pattern on the illumination object I. By superimposing a variety of speckle patterns on the illumination object I, it is possible to make a recognition of a specific speckle pattern difficult, enabling an effective reduction of the speckle. In this way, an advantageous effect is achieved in that, when using in conjunction with the hold type spatial light modulator, it is possible to lessen a reduction in moving picture response, and to reduce the speckle.

The light source 11 is not limited to a configuration in which the five laser diodes 12 are aligned in the X direction. It is sufficient that it has a configuration in which a plurality of laser diodes 12 is aligned. Also, it is also acceptable that it has a configuration in which the laser diodes 12 are aligned in the Y direction, rather than the X direction. In this case, it is possible that the lighting device 10 has a configuration which causes a linear luminous flux approximately parallel to the Y direction, which is the first direction, to scan in the X direction, which is the second direction. Furthermore, it is also acceptable that the light source 11 has a configuration in which the laser diodes 12 are aligned in an array formation in the X direction and the Y direction. In this case, it is possible that the diffractive optical element 13 has a configuration in which it shapes a plurality of laser beams aligned in the array formation in the X direction and the Y direction into a linear luminous flux. The scanner is not limited to being the rotating prism 15, as it is also acceptable to use an acoustooptical element (AOC), or a reflecting mirror described hereafter in a modification example 2 etc.

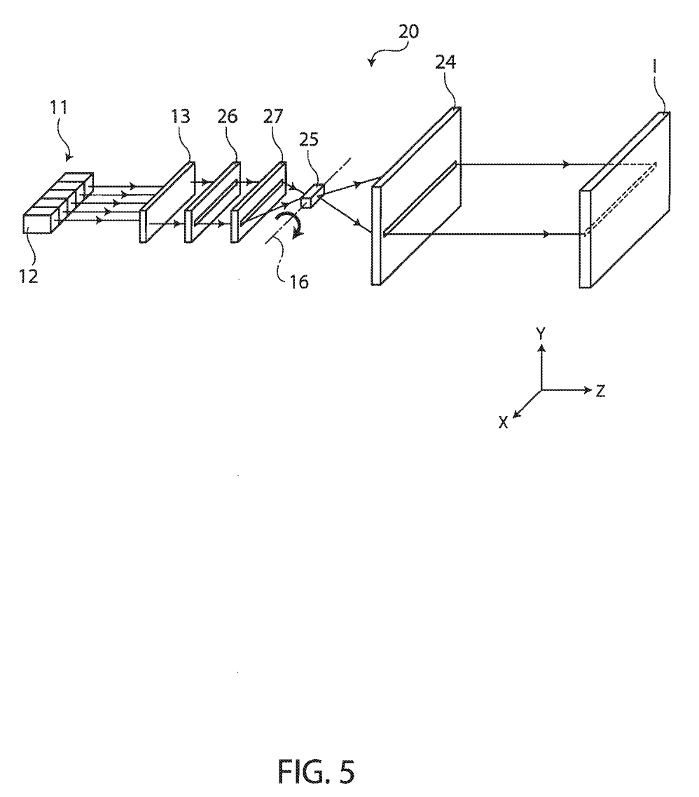

FIG. 5 shows an outline configuration of a fighting device 20 according to a modification example 1 of the embodiment. The lighting device 20 in the modification example causes a focusing optical portion to focus linear luminous fluxes in an optical path between a shaping optical portion and a parallelizing optical portion. A collimator 26 and a focusing optical portion 27 are provided on an emergence side of the diffractive optical element 13. A rotating prism 25, which is a scanner, being in an optical path between the diffractive optical element 13, which is the shaping optical portion, and a collimator 24, which is the parallelizing optical portion, is provided between the focusing optical portion 27 and the collimator 24.

The diffractive optical element 13 superimposes five laser beams at a collimator 26. The collimator 26 parallelizes the linear luminous fluxes from the diffractive optical element 13. The focusing optical portion 27 focuses the linear luminous fluxes in a position of the rotating prism 25, or a proximity thereof. A diffractive optical element such as a CGH etc., or a lens, can be used as the collimator 26 and the focusing optical portion 27. The rotating prism 25 causes the linear luminous fluxes to scan in the Y direction, which is a second direction approximately perpendicular to the first direction. The rotating prism 25 transmits the linear luminous fluxes while rotating around the rotation axis 16.

By subsequently diffusing the linear luminous fluxes focused in the position of the rotating prism 25, or the proximity thereof, they can be stretched to an extent of a width of the illumination object I. The linear luminous fluxes stretched to the extent of the width of the illumination object I, after being parallelized by the collimator 24, are incident on the illumination object I. By having a configuration in which the linear luminous fluxes focused between the focusing optical portion 27 and the collimator 24 are made incident on the rotating prism 25, it is possible to make the rotating prism 25 more compact compared with a case of making linear luminous fluxes of a width approximately the same as that of the illumination object I incident on the rotating prism. In this way, it is possible to make a drive motor of the rotating prism 25 more compact, and to reduce power consumption. Also, it is possible to make the rotating prism 25 and each peripheral portion compact, leading to a cost reduction and a size reduction of the lighting device 20.

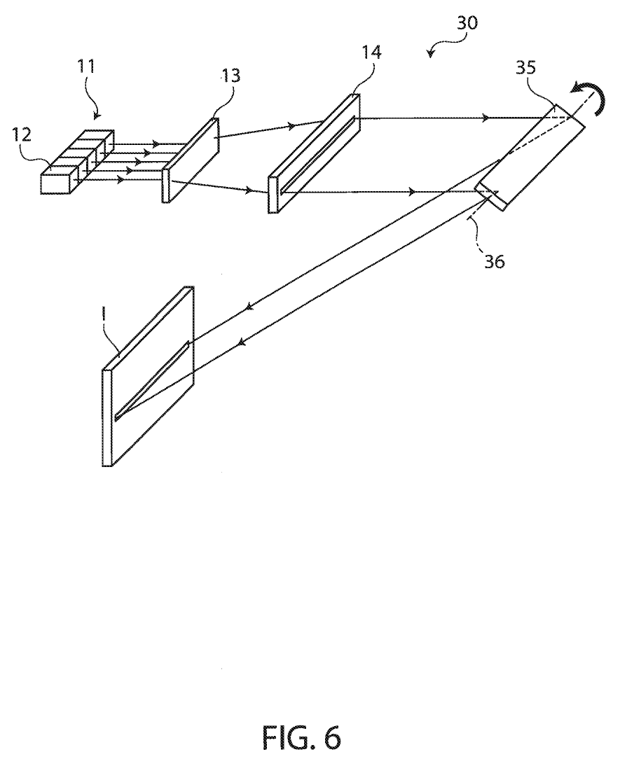

FIG. 6 shows an outline configuration of a lighting device 30 according to a modification example 2 of the embodiment. The lighting device 30 in the modification example includes a reflecting mirror 35 causing linear luminous fluxes to scan, in place of a rotating prism. The reflecting mirror 35 reflects the linear luminous fluxes while rotating around a rotation axis 36 approximately parallel to the first direction. The reflecting mirror 35 is a scanner causing the linear luminous fluxes to scan in the second direction, which is approximately perpendicular to the first direction. The reflecting mirror 35 can be formed by coating a substrate, consisting of a parallel plate, with a highly reflective material. As the optical path is deflected by the reflecting mirror 35, the lighting device 30 in the modification example causes light to emerge toward the illumination object I provided on the light source 11 side seen from the reflecting mirror 35.

By causing the reflecting mirror 35 to rotate around the rotation axis 36 in a direction of an arrow in the figure, it is possible to move the linear luminous fluxes downward in the illumination object I. At an instant after the linear luminous fluxes arrive at a lower end portion of the illumination object I, causing the reflecting mirror 35 to rotate in a direction opposite to the arrow moves the linear luminous fluxes upward in the illumination object I. Then, the reflecting mirror 35, by rotating again in the direction of the arrow, moves the linear luminous fluxes downward. In this way, the reflecting mirror 35 repeats a flyback scan causing the linear luminous fluxes to scan in a specific direction, for example a downward direction, in the second direction. Apart from this, it is also acceptable that the reflecting mirror 35 repeats a forward and reverse rotation in order to cause the linear luminous fluxes to scan up and down repeatedly. In this way, it is possible to cause the linear luminous fluxes to scan in the illumination object I.

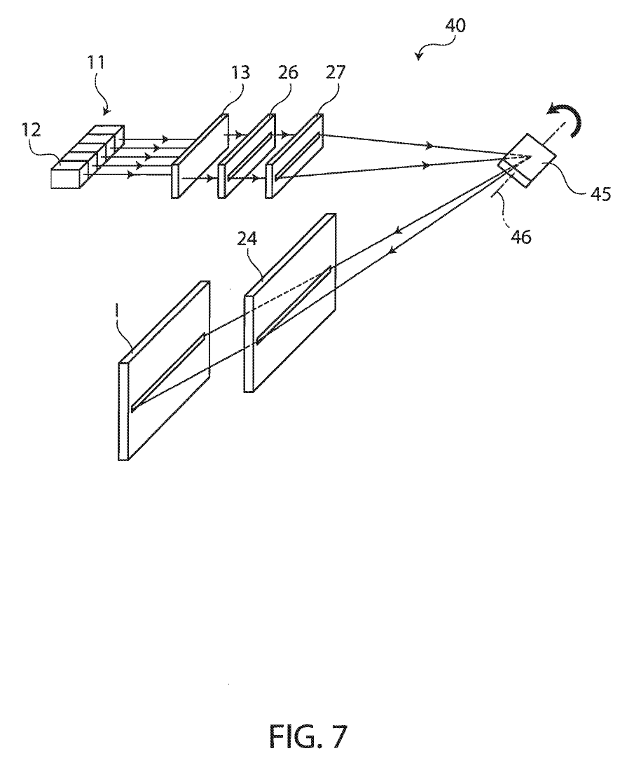

By using the reflecting mirror 35, it is possible to cause the linear luminous fluxes to scan using a simple configuration. Also, by having a configuration in which the optical path is deflected by the reflecting mirror 35, it is possible to make the overall length of the lighting device 30 shorter than in a case in which light is caused to proceed in a straight line along every optical path of the lighting device. It is also acceptable to use a polygon mirror, rotating a plurality of mirror pieces around a rotation axis, in place of the reflecting mirror 35. Also, as in a lighting device 40 shown in FIG. 7, it is also acceptable to cause the linear luminous fluxes to focus, with the focusing optical portion 27, in a position of a reflecting mirror 45 or a proximity thereof. The reflecting mirror 45 is provided in an optical path between the focusing optical portion 27 and the collimator 24. The reflecting mirror 45 reflects the linear luminous fluxes while rotating around a rotation axis 46 approximately parallel to the first direction.

By subsequently diffusing the linear luminous fluxes focused in the position of the reflecting mirror 45, or the proximity thereof, they can be stretched to an extent of a width of the illumination object I. The linear luminous fluxes stretched to the extent of the width of the illumination object I, after being parallelized by the collimator 24, are incident on the illumination object I. By having a configuration in which the linear luminous fluxes focused between the focusing optical portion 27 and the collimator 24 are made incident on the reflecting mirror 45, it is possible to make the reflecting mirror 45 compact. In this way, it is possible to greatly improve an operating response of the reflecting mirror 45, enabling a more compact drive motor and a reduction in power consumption. Also, it is possible to make the reflecting mirror 45 and each peripheral portion compact, leading to a cost reduction and a size reduction of the lighting device 40.

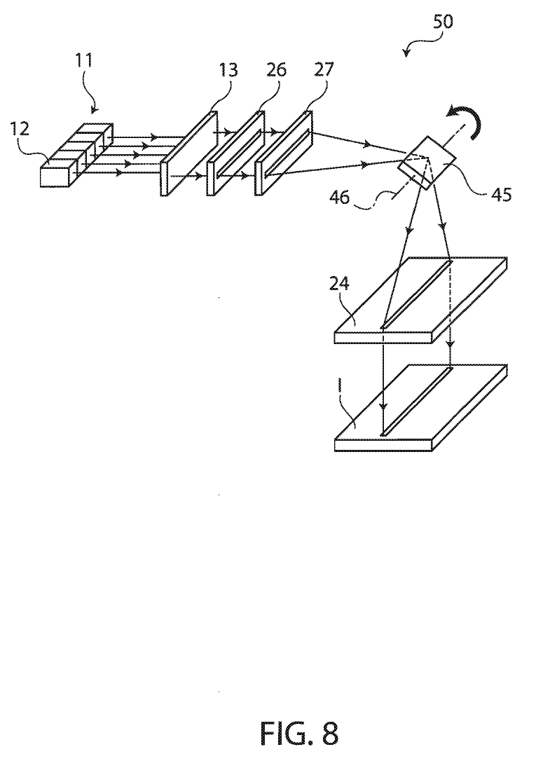

Furthermore, as in a lighting device 50 shown in FIG. 8, it is also acceptable to have a configuration deflecting the linear luminous fluxes approximately 90 degrees and causing them to scan with the reflecting mirror 45. The reflecting mirror 45 causes the linear luminous fluxes to scan centered on a direction deflecting light from the focusing optical portion 27 approximately 90 degrees. By means of such a configuration, it is possible to make a compact configuration for the lighting device 50.

### Embodiment 2

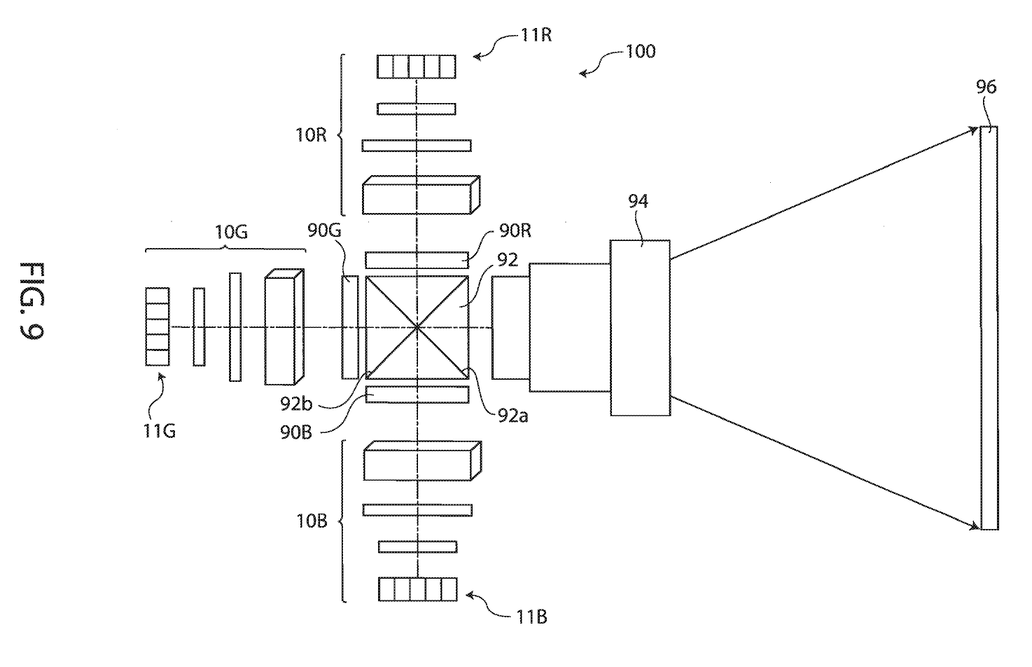

FIG. 9 shows an outline configuration of a projector 100 according to Embodiment 2 of the invention. The projector 100 is a so-called front projection type of projector in that it supplies light to a screen 96 provided on a viewer side, whereon an image is appreciated by viewing light reflected on the screen 96. The projector 100 includes lighting devices 10R, 10G and 10B for each colored light, configured in the same way as the lighting device 10 according to Embodiment 1.

A red light (hereafter referred to as “R light”) light source 11R provided in an R light lighting device 10R, supplies red light. A green light (hereafter referred to as “G light”) light source 11G provided in a G light lighting device 10G, supplies green light. A blue light (hereafter referred to as “B light”) light source 11B provided in a B light lighting device 10B, supplies blue light. The projector 100 includes a plurality of light sources 11R, 11G and 11B which supply the R light, the G light and the B light, which are mutually differing colored lights.

The R light lighting device 10R supplies the R light to an R light spatial light modulator 90R, which is an illumination object. The R light spatial light modulator 90R is a transmissive liquid crystal display device which modulates the R light in accordance with an image signal. The R light modulated by the R light spatial light modulator 90R is incident on a cross dichroic prism 92, which is a color synthesizing optical system. The G light lighting device 10G supplies the G light to a G light spatial light modulator 90G, which is an illumination object. The G light spatial light modulator 90G is a transmissive liquid crystal display device which modulates the G light in accordance with an image signal. The G light modulated by the G light spatial light modulator 90G is incident on a cross dichroic prism 92, which is a color synthesizing optical system. The B light lighting device LOB supplies the B light to a B light spatial light modulator 90B, which is an illumination object. The B light spatial light modulator 90B is a transmissive liquid crystal display device which modulates the B light in accordance with an image signal. The B light modulated by the B light spatial light modulator 90B is incident on a cross dichroic prism 92, which is a color synthesizing optical system

The cross dichroic prism 92 includes two dichroic films 92A and 92B, disposed in such a way as to be approximately perpendicular to each other. A first dichroic film 92A reflects the R light while transmitting the G light and the B light. A second dichroic film 92B reflects the B light while transmitting the G light and the R light. In this way, the cross dichroic prism 92 synthesizes the R light, the G light and the B light modulated in the spatial light modulators 90R, 90G and 90B, respectively. A projecting optical system 94 projects the light synthesized by the cross dichroic prism 92 onto the screen 96.

As the projector 100 includes the lighting devices 10R, 10G and 10B for the corresponding colored lights, configured in the same way as the lighting device 10 according to Embodiment 1, it is possible to lessen a reduction in a moving picture response even when using the hold type spatial light modulators 90R, 90G and 90B, and it is possible to reduce speckle. In this way, an advantageous effect is achieved in that it is possible to display a high quality image in which a moving picture blur and speckle have been reduced. Even in the event that the projector 100 uses, rather than the lighting device 10 described in Embodiment 1, another lighting device described in Embodiment 1, an identical advantageous effect can be obtained.

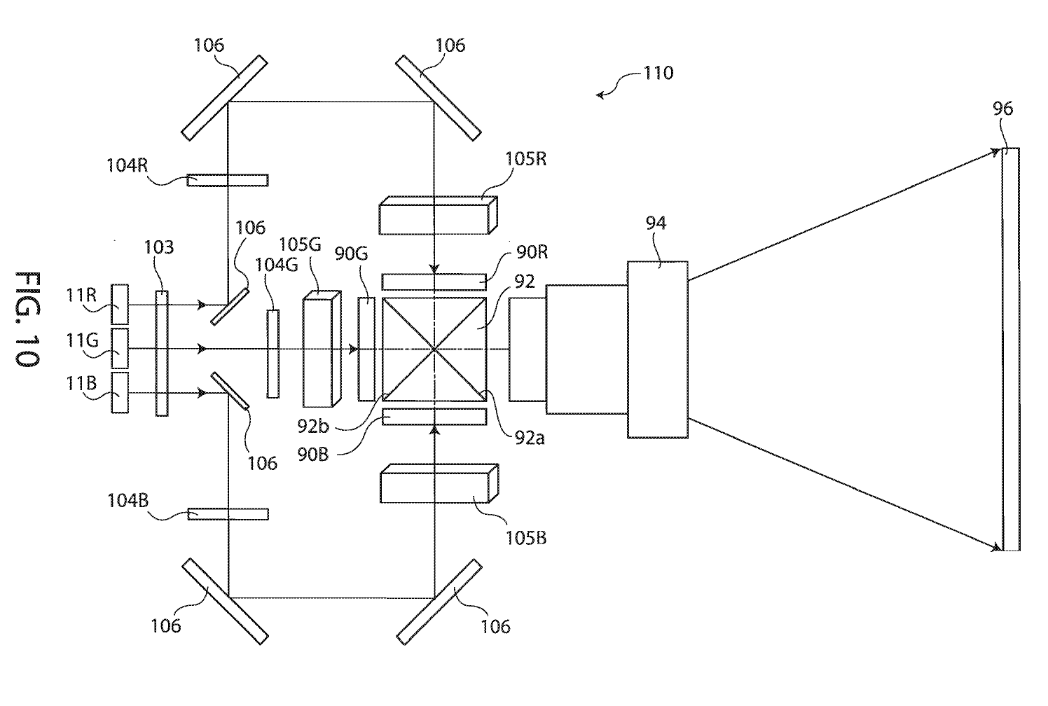

Not being limited to a configuration providing the light sources 11R, 11G and 11B separately, as in a projector 110 shown in FIG. 10, it is also acceptable to have a configuration providing the light sources 11R, 11G and 11B integrated. A diffractive optical element 103 is provided on an emergence side of the light sources 11R, 11G and 11B. After the R light from the R light light source 11R passes through the diffractive optical element 103, its optical path is deflected approximately 90 degrees by a reflector 106, then falls incident on an R light collimator 104R. The R light from the R light collimator 104R passes through two reflectors 106, and falls incident on an R light rotating prism 105R. The R light rotating prism 105R causes the R light to scan at the R light spatial light modulator 90R. As well as between the reflector 106 and the R light spatial light modulator 90R, it is also acceptable to install the R light rotating prism 105R in any position between the two reflectors 106, between the R light collimator 104R and the reflector 106 and the like.

After the G light from the G light light source 11G passes through the diffractive optical element 103, it proceeds in a straight line and falls incident on a G light collimator 104G. The G light from the G light collimator 104G falls incident on a G light rotating prism 105G. The G light rotating prism 105G causes the G light to scan at the G light spatial light modulator 90G. After the B light from the B light light source 11B passes through the diffractive optical element 103, its optical path is deflected approximately 90 degrees by a reflector 106, then falls incident on a B light collimator 104B. The B light from the B light collimator 104B passes through two reflectors 106, and falls incident on a B light rotating prism 105B. The B light rotating prism 105B causes the B light to scan at the B light spatial light modulator 90B. As well as between the reflector 106 and the B light spatial light modulator 90B, it is also acceptable to install the B light rotating prism 105B in a position between the two reflectors 106, between the B light collimator 104B and the reflector 106 and the like.

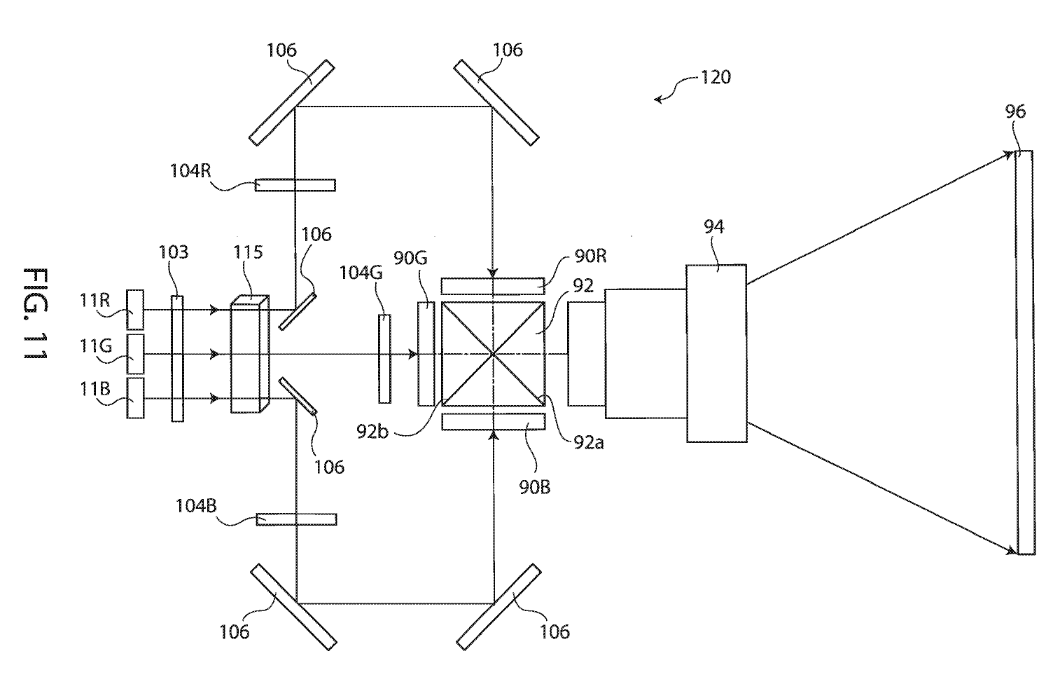

Furthermore, it is also acceptable, as in a projector 120 shown in FIG. 11, to cause each colored light from the diffractive optical element 103 to scan with one rotating prism 115. The rotating prism 115 is a scanner causing the colored light from the plurality of light sources 11R, 11G and 11B to scan. The rotating prism 115 is provided on an emergence side of the diffractive optical element 103. The R light which has passed through the rotating prism 115, after having its optical path deflected approximately 90 degrees by the reflector 106, falls incident on the R light collimator 104R. The R light from the R light collimator 104R passes through the two reflectors 106, and falls incident on the R light spatial light modulator 90R.

The G light which has passed through the rotating prism 115 proceeds in a straight line, and falls incident on the G light collimator 104G. The G light from the G light collimator 104G falls incident on the G light spatial light modulator 90G. The B light which has passed through the rotating prism 115, after having its optical path deflected approximately 90 degrees by the reflector 106, falls incident on the B light collimator 104B. The B light from the B light collimator 104B passes through the two reflectors 106, and falls incident on the B light spatial light modulator 90B. By having a configuration in which the rotating prism 115 causes a plurality of colored lights to scan, it is possible to reduce the number of parts of the projector 120 compared with a case in which a rotating prism is provided for each colored light, to reduce a cost of the projector 120, and to make it compact.

The R light collimator 104R is not limited to being provided between the two reflectors 106 shown in FIG. 11. As long as it is possible to correctly cause the linear luminous fluxes to scan in the R light spatial light modulator 90R, it is acceptable to install the R light collimator 104R in any position in a light path between the rotating prism 115 and the R light spatial light modulator 90R. In the same way, it is acceptable to install the B light collimator 104B in any position in a light path between the rotating prism 115 and the B light spatial light modulator 90B.

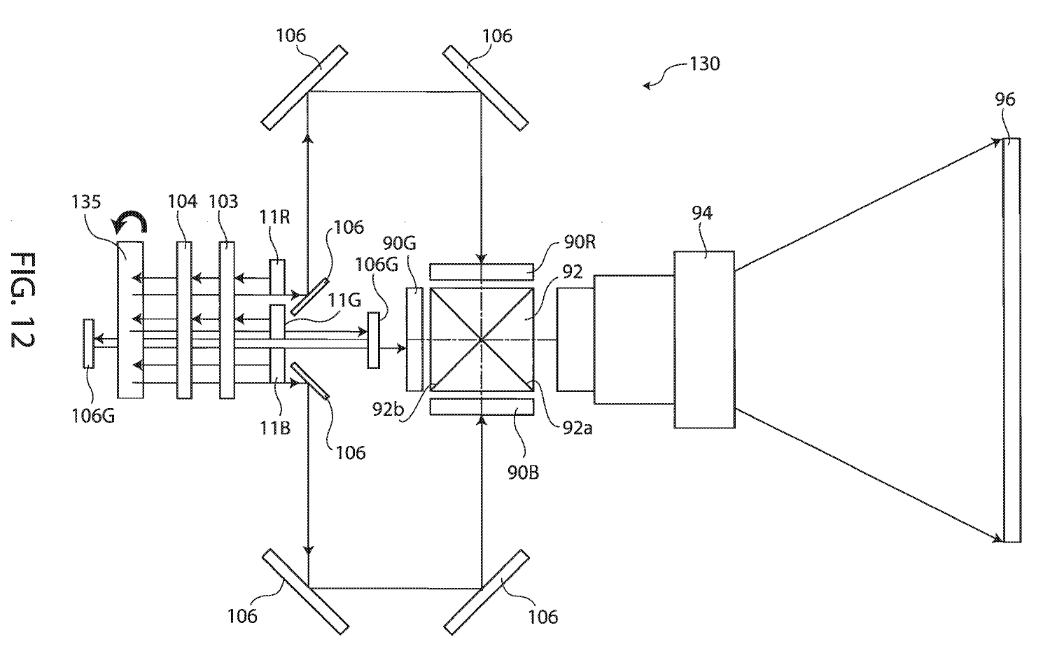

Furthermore, it is also acceptable, as in a projector 130 shown in FIG. 12, to cause each colored light from the diffractive optical element 103 to scan with one reflecting mirror 135. The diffractive optical element 103 provided in the projector 130 is provided on an emergence side of the light sources 11R, 11G and 11B. The collimator 104 parallelizes each colored light emerging from the diffractive optical element 103. Each colored light which has passed through the collimator 104 falls incident on the reflecting mirror 135.

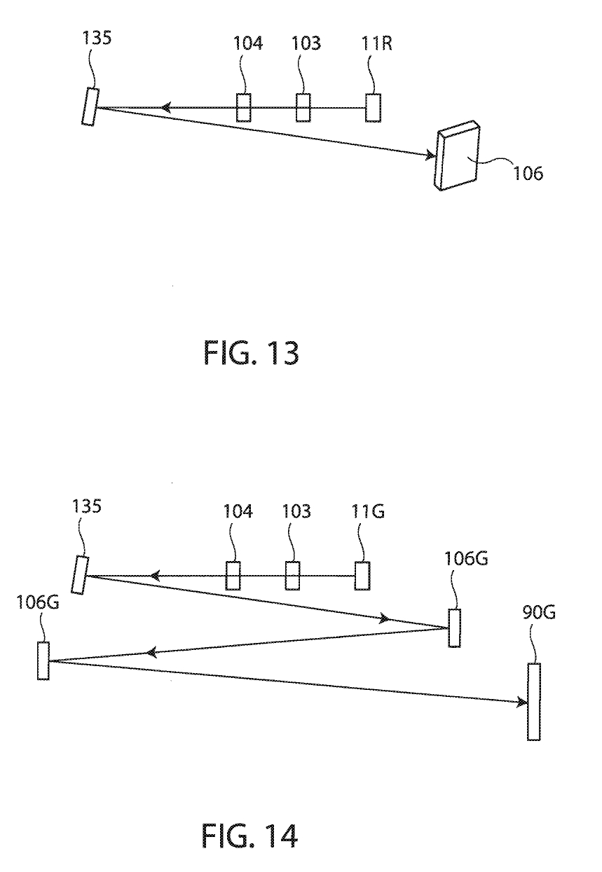

FIG. 13 illustrates an R light optical path on a plane approximately vertical to the plane of FIG. 12. After the R light from the R light source 11R passes through the diffractive optical element 103 and the collimator 104, its optical path is deflected in a direction opposite to thus far by the reflecting mirror 135. The R light reflected from the reflecting mirror 135 falls incident on the reflector 106. Returning to FIG. 12, the R light from the reflecting mirror 135 passes through three reflectors 106, and falls incident on the R light spatial light modulator 90R. The B light from the B light source 11B also passes along the same optical path as the R light, and falls incident on the B light spatial light modulator 90B.

FIG. 14 illustrates a G light optical path on a plane approximately vertical to the plane of FIG. 12. After the G light from the G light source 11G passes through the diffractive optical element 103 and the collimator 104, its optical path is deflected in a direction opposite to thus far by the reflecting mirror 135. The G light reflected from the reflecting mirror 135 further repeats a coming and going due to a reflection by two reflectors 106G. The G light which has passed through the two reflectors 106G falls incident on the G light spatial light modulator 90G. The two reflectors 106G are provided to adjust a difference between a light wavelength of the R light and the B light.

By means of such a configuration, it is possible to cause the linear luminous fluxes for each colored light to scan using one reflecting mirror 135. By having a configuration in which the reflecting mirror 135 causes a plurality of colored lights to scan, it is possible to reduce the number of parts of the projector 130 compared with a case in which a reflecting mirror is provided for each colored light, to reduce a cost of the projector 130, and to make it compact. Even in the event that the projector 130 uses, rather than a configuration the same as that of the lighting device 30 described in Embodiment 1 (refer to FIG. 6), a configuration the same as that of another lighting device described in Embodiment 1, an identical advantageous effect can be obtained. For example, in a case of using a configuration the same as that of the lighting device 50 in FIG. 8, it is possible to have a configuration deflecting each colored light approximately 90 degrees with the reflecting mirror 135.

Each projector in the embodiments is not limited to a so-called 3LCD projector provided with three transmissive liquid crystal display devices, as it is also acceptable to have, for example, a projector using one transmissive liquid crystal display device or a projector using a reflective liquid crystal display device. Also, it is also acceptable that the colored light spatial light modulators 90R, 90G and 90B are a minute mirror array device driving a minute mirror, rather than a liquid crystal display device. The projector is not limited to a front projection type, as it is also acceptable that it is a so-called rear projector which supplies a laser beam to one surface of a screen, whereon an image is appreciated by viewing light emerging from the other surface of the screen.

As described heretofore, the lighting devices according to the invention are suitable as a lighting device of a projector displaying an image using a laser beam.

While this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. There are changes that may be made without departing from the sprit and scope of the invention.

The entire disclosure of Japanese Patent Application No. 2005-377156, filed Dec. 28, 2005 is expressly incorporated by reference herein.

What is claimed is:

1. A lighting device comprising:
a light source which supplies a beam;
a shaping optical portion which shapes the beam into a linear luminous flux approximately parallel to a first direction; and
a scanner which causes the linear luminous flux to scan in a second direction approximately perpendicular to the first direction.

2. The lighting device according to claim 1, wherein
the shaping optical portion makes a light quantity distribution of the linear luminous flux approximately even.

3. The lighting device according to claim 1, wherein
the shaping optical portion includes a diffractive optical element which shapes the beam into the linear luminous flux by diffraction.

4. The lighting device according to claim 1, comprising:
a parallelizing optical portion which parallelizes the linear luminous flux from the shaping optical portion.

5. The lighting device according to claim 1, wherein
the scanner includes a rotating prism which transmits the linear luminous flux while rotating around a rotation axis.

6. The lighting device according to claim 1, wherein
the scanner includes a reflecting mirror which reflects the linear luminous flux while rotating around a rotation axis.

7. The lighting device according to claim 1, wherein
the light source supplies a plurality of the beams which are isochromatic.

8. The lighting device according to claim 1, wherein
the light source supplies laser beams, which are the aforementioned beams.

9. The lighting device according to claim 1, comprising:
a plurality of the light sources which supply mutually differing colored lights, wherein
the scanner causes the colored lights from the plurality of light sources to scan.

10. A projector, comprising:
a light source which supplies a beam;
a shaping optical portion which shapes the beam into a linear luminous flux approximately parallel to a first direction;
a scanner which causes the linear luminous flux to scan in a second direction approximately perpendicular to the first direction; and
a spatial light modulator which modulates light from the scanner in accordance with an image signal.

11. The projector according to claim 10, wherein
the shaping optical portion makes a light quantity distribution of the linear luminous flux approximately even.

12. The projector according to claim 10, wherein
the shaping optical portion includes a diffractive optical element which shapes the beam into the linear luminous flux by diffraction.

13. The projector according to claim 10, comprising
a parallelizing optical portion which parallelizes the linear luminous flux from the shaping optical portion.

14. The projector according to claim 10, wherein
the scanner includes a rotating prism which transmits the linear luminous flux while rotating around a rotation axis.

15. The projector according to claim 10, wherein
the scanner includes a reflecting mirror which reflects the linear luminous flux while rotating around a rotation axis.

16. The projector according to claim 10, wherein
the light source supplies a plurality of the beams which are isochromatic.

17. The projector according to claim 10, wherein
the light source supplies laser beams, which are the aforementioned beams.

18. The projector according to claim 10, comprising:
a plurality of the light sources which supply mutually differing colored lights, wherein
the scanner causes the colored lights from the plurality of light sources to scan.
